(19) United States
(12) Patent Application Publication
(10) Pub. No.: US 2024/0243251 A1
(43) Pub. Date: Jul. 18, 2024

(54) PROCESS FOR MANUFACTURING A STACK OF ELECTRODE SHEETS, AND CUTTING DEVICE, SPACING ELEMENT AND CROSS-CUTTING DEVICE THEREFOR

(71) Applicant: Volkswagen Aktiengesellschaft, Wolfsburg (DE)

(72) Inventors: Kartik JAMADAR, Wolfsburg (DE); Christian THEUERKAUF, Braunschweig (DE); Christian PUSCHMANN, Vechelde (DE); Lars FIERKAU, Wendeburg (DE); Marco JORDAN, Salzgitter (DE); Gunder GRESENS, Wolfenbuettel (DE); Frank ZIERAU, Salzgitter (DE); Timo BASSE, Lengede (DE)

(73) Assignee: Volkswagen Aktiengesellschaft, Wolfsburg (DE)

(21) Appl. No.: 18/585,973

(22) Filed: Feb. 23, 2024

Related U.S. Application Data
(63) Continuation of application No. PCT/EP2022/068281, filed on Jul. 1, 2022.

(30) Foreign Application Priority Data
Aug. 23, 2021 (DE) 10 2021 209 224.1

(51) Int. Cl. H01M 4/139; H01M 10/0585; H01M 50/249; H01M 50/46

(52) U.S. Cl. CPC H01M 4/139; H01M 10/0585; H01M 50/249; H01M 50/46

(57) ABSTRACT

A method for producing a stack of electrode sheets, as well as a cutting device and spacer element and a trimmer therefor. In the method for producing the stack of electrode sheets, the stack comprises at least two electrode sheets arranged one on top of the other along a stacking direction, which, at least along a direction of stacking is substantially perpendicular to the axial direction, have a different extension.

This nonprovisional application is a continuation of International Application No. PCT/EP2022/068281, which was filed on Jul. 1, 2022, and which claims priority to German Patent Application No. 10 2021 209 224.1, which was filed in Germany on Aug. 23, 2021, and which are both herein incorporated by reference.

### BACKGROUND OF THE INVENTION

### Field of the Invention

The invention relates to a method for producing a stack of electrode sheets. As part of the method, a plurality of electrode foils are cut to length together and the cut parts of the electrode foils, the electrode sheets, are stacked on top of each other. The electrode sheets are used in particular in a battery cell, preferably a secondary battery cell.

### Description of the Background Art

Batteries, especially lithium-ion batteries, are increasingly being used to power motor vehicles. Batteries are usually composed of cells, wherein each cell has a stack of electrode sheets, namely anode, cathode, and separator sheets. At least some of the anode and cathode sheets are designed as current collectors to discharge the current provided by the cell to a consumer located outside the cell.

In the production of a lithium-ion battery cell, a so-called carrier material, in particular a ribbon-shaped substrate, e.g., a carrier foil, is preferably coated on both sides with at least one active material. The carrier foil forms a current collector of the battery cell. The coated substrate forms an electrode foil, such as an anode or a cathode.

Other substrates are coated with a separator material and also form electrode foils, namely separators.

In particular, the electrode foil is an endless material that can be separated into electrode sheets via cutting processes. These electrode sheets can be used in battery cells.

In conventional battery cells, the separators are usually larger than the anodes and the anodes are larger than the cathodes. In particular, the separators have a circumferential oversize as compared to the anodes of a stack, e.g., a circumferential edge of a width of 1.5 millimeters. In particular, the separators have a circumferential oversize as compared to the cathodes of a stack, e.g., a circumferential edge of 3 millimeters. Correspondingly, the anodes have a circumferential oversize as compared to the cathodes of a stack, e.g., a circumferential edge of 1.5 millimeters.

It has proven to be very difficult to produce this oversize in high-speed stacking systems with a consistent quality. The usual tolerance here is a maximum deviation of 0.5 millimeters. Currently, a separator is cut and then collected in a magazine. Similarly, the cathode and anode are collected in separate magazines. The individual electrode sheets are removed one after the other from the respective magazine (anode, separator, cathode and separator) and placed on a turntable. A camera is used to accurately position each electrode sheet. This stacking process is also known as a pick and drop stacking process. Currently, the positioning and placement of a single electrode sheet takes at least 1 second. This means that a stack of 4 electrode sheets takes 4 seconds. A battery cell with 30 stacks then needs about 120 seconds. In addition, the electrode foils are very thin, especially the separator, for example, is only about 0.02 millimeters thick, and therefore difficult to transport. There is a risk of creasing. Such a process is not suitable for the mass production of battery cells.

Another process involves Z-folding. Here, the anode and cathode are cut to the final size. The separator (also in the battery cell or in the formed stack) has the shape of a coil and makes a Z-shaped movement. The cathode and anode are positioned above the Z-shaped separator. The stacking process is fast, but more separator is used at the bend around the anode or cathode, which increases the cost and weight. The bending stress in the separator is uneven.

From US 2018/0138553 A1, such a stacking device for a lithium-ion battery is known. In this process, a separator is provided as continuous material and folded into a Z-shape. An anode plate and a cathode plate are arranged alternately on different sides of the separator. The separator, coated with the sheets, is folded into a stack.

From US 2014/0212729 A1, an electrode arrangement comprising two electrodes and two separators is known. The electrodes are different sizes from each other. The separators are larger than the electrodes.

### SUMMARY OF THE INVENTION

It is therefore an object of the present invention to solve, at least in part, the problems raised with reference to the prior art. In particular, a method for producing a stack of electrode sheets is proposed, via which a high speed of the manufacturing process is achieved while maintaining low cost and high product quality.

Thus, a method for producing a stack of electrode sheets is proposed. The stack includes at least two electrode sheets arranged on top of each other along a stacking direction, which have a different extension at least along an axial direction running perpendicular to the stacking direction.

The method comprises at least the following steps:
a) Providing a first electrode foil as continuous material from a first staging device, e.g., from a first roll;
b) Providing a second electrode foil as continuous material from a second staging device, e.g., from a second roll;
c) Bringing the electrode foils together so that they are arranged opposite or on top of each other, each with their largest side faces;
d) Jointly fixing the electrode foils arranged on top of each other in a first section via a first clamping device;
e) Arranging a spacer element between the electrode foils in a second section, which is arranged along the axial direction between the first section and the staging devices;
f) Extending the length of at least one of the electrode foils, wherein the length extends along the electrode foil between the first section and the respective staging device with respect to the length of the other electrode foil, by at least shaping the spacer element or by moving the spacer element at least along a radial direction perpendicular to the axial direction and to the largest side faces;
g) Cutting the electrode foils in the second section to length, so that a stack of electrode sheets with different extensions is formed between the first section and the second section.

The above (non-exhaustive) arrangement of the method steps into a) to g) primarily serves only to distinguish and does not enforce any sequence and/or dependence. The frequency of the method steps can also vary. It is also possible that method steps overlap each other, at least partially. In particular, method steps a) to c) take place before steps d) to g). In particular, steps (a) to (c) are carried out continuously, while steps (d) to (g) are carried out repeatedly. Preferably, steps a) to c) are carried out during steps d) to g). In particular, steps (a) to (g) are carried out in the order indicated, wherein, in particular, after a single pass of steps (a) to (g), steps (a) to (c) are carried out continuously and steps (d) to (g) are carried out one after the other in continuous repetition.

Here, the method for two electrode foils is described. In particular, the method is also suitable for more than two, preferably for four, electrode foils. When performed with four electrode foils, the method can form a stack of electrode sheets, comprising an anode, a cathode and two separators.

The method is used in particular for the processing of coated electrode foils. In particular, the coating includes materials for use in lithium-ion battery cells.

The electrode foils are provided by the staging device, in particular as continuous material.

In particular, the electrode sheets produced by the method have a geometry that is intended and suitably designed for use in a battery cell.

The coating is arranged along the conveying direction, especially continuously, preferably on both sides, on the carrier material of the electrode foil. On the sides of the electrode foil, which is designed as a continuous material, uncoated areas can be provided, if necessary also continuously along the conveying direction. These uncoated areas can form the arrester tabs of the electrode sheets.

In steps (a) and (b), the different electrode foils, in particular coated substrates, are each provided by a staging device. Prior to step c), these electrode foils are in particular pre-coated and/or trimmed at the edges running parallel to the axial direction. For example, the anodes and cathodes have the current collectors (also known as arrester tabs) at the edges.

Step (c) involves bringing the electrode foils together so that they are opposite each other or stacked on top of each other, each with their largest side faces. In particular, the electrode foils, which are available as continuous material, are arranged with their edges running parallel to the axial direction, in line with each other, or in the position of these edges intended for the later stack of electrode sheets. For example, the electrode foils are arranged in such a way that the nominal oversize of the electrode sheets in the stack is set with respect to the edges, parallel to the axial direction.

In step d), the electrode foils arranged on top of each other are fixed together in a first section via a first clamping device. For example, the clamping device comprises two clamping jaws between which the electrode foils are clamped. In particular, the clamping device contacts (exclusively) the largest side faces of the electrode foils, i.e., the underside of the bottom electrode foil and the top of the uppermost electrode foil.

In step (e), a spacer element is arranged between the electrode foils in a second section, which is arranged along the axial direction between the first section and the staging devices. In this second section, the electrode foils are arranged at a (small) distance from each other, so that the spacer element can be inserted or swiveled in between the electrode foils. If several electrode foils are provided, a separate spacer element can be arranged, for example, between each of the two adjacent electrode foils.

Step (f) involves extending the length of at least one of the electrode foils, wherein the length extends along the electrode foil between the first section and the respective staging device. The length is extended in relation to the length of the other electrode foil by shaping the spacer element and/or moving the spacer element at least along a radial direction perpendicular to the axial direction and to the largest side faces. The extension can be achieved, for example, by a kind of labyrinth guidance of the electrode foil, wherein the shape or movement of the spacer element creates this labyrinth. In particular, such an electrode foil can be extended almost arbitrarily, regardless of its position in the stack. The measure of the extension of the electrode foil is provided in particular by the staging device, e.g., by unwinding the measure of the extension, since in the first section the electrode foils are arranged together in a clamped manner.

The measure of the extension is determined by the shape of the spacer element or by its movement along the radial direction. The spacer element changes the length of the electrode foil between the first section in which the electrode foil is fixed and the staging device, i.e., enlarges it.

If several electrode foils are provided, the length of each individual electrode foil between the first section and the respective staging device can be changed and adjusted by each designated spacer element.

In step g), the electrode foils are cut in the second section, so that a stack of electrode sheets is formed between the first section and the second section, each with different extensions from each other.

In particular, a cutter is provided for cutting, which is designed in particular as a component of the spacer element or interacts with it. In particular, each cutter is used exclusively for anodes (and possibly separators) or for cathodes (and possibly separators) in order to avoid contamination of the active materials.

In particular, the cutting of the electrode foils is carried out in such a way that the spacer element sets an extension of the length between the first section and the second section, more precisely between the first section and the separation point in the second section.

In particular, the cutting of the electrode foils is carried out in such a way that, via the spacer element, the extension of the length between the first section and the second section and the extension of the length between the second section and the staging device are the same. This means that the electrode sheet formed by cutting the electrode foil has the same amount of oversize at each end along the axial direction as that of the other electrode sheet.

However, the extension of the length between the first section and the second section and the extension of the length between the second section and the staging device can also be set differently, so that the electrode sheet formed by cutting the electrode foil has a different amount of oversize at each end along the axial direction as compared to the other electrode sheet.

In step g, the electrode sheets are generated, wherein each electrode sheet can be produced with its own extension along the axial direction. In this case, the individual electrode sheets of the stack are already arranged on top of each other with the correct oversize with respect to the axial direction and can thus be further processed.

In particular, between steps (f) and (g) in a step x, the electrode foils arranged on top of each other are fixed together via a second clamping device in a third section, which is arranged between the second section and the staging devices. In particular, the explanation regarding the first clamping device applies equally to the second clamping device.

The fixing according to step x. always takes place only after step f), so that the extension of the length of the respective electrode foil, which is provided, for example, by unwinding from the staging device, is not impaired or prevented. As a result of the fixing by the second clamping device, it is ensured that the electrode foils are fixed in their position after the electrode sheets have been separated.

In particular, between steps x. and g) in a step y., the first clamping device, the second clamping device and the spacer element together with the fixed electrode foils are moved along the axial direction.

In particular, series production can be realized in which the individual method steps are carried out in constant repetition on the electrode foils, so that a large number of stacks can be produced one after the other.

In particular, after step (g), in a further step h), the stack of electrode sheets is fixed by a third clamping device. The third clamping device is arranged in particular along the axial direction between the first section (or the first clamping device) and the second section. The explanations regarding the first and second clamping devices apply here, in particular, accordingly.

In particular, after step h), in a further step i), the spacer element is removed from the stack and the first clamping device is released. In particular, the spacer element is first removed from the stack and then the first clamping device is released. The electrode sheets continue to be fixed by the third clamping device and thus fixed in their position in relation to each other.

In particular, after step (i), in a further step (j), the stack of electrode sheets is transported further by the third clamping device. This stack of electrode sheets can, for example, be put to further use with the third clamping device.

In particular, after step (i)—and in particular independently of step j), e.g., parallel in time to step j)—in a further step (k), the second clamping device and the electrode foils fixed by it are shifted along the axial direction.

In particular, series production can be realized in this way, in which the individual method steps are carried out in constant repetition on the electrode foils, so that a large number of stacks can be produced one after the other.

In particular, after step (k), the second clamping device forms the first clamping device and the method is continued with step (e). After step k), the second clamping device forms, in particular, the first clamping device and thus already implements step d) of the method.

In particular, the stack has at least one first electrode sheet and one second electrode sheet, and a first end and a second end along the axial direction. The first electrode sheet has an oversize at each end along the axial direction with respect to the second electrode sheet. The oversize can be the same amount at each end or different from each other.

If more than two electrode foils are processed into the stack in the method, each electrode sheet has a (negative or positive) oversize in relation to the adjacent electrode sheet, i.e., the electrode sheets arranged adjacent to each other have different extensions from each other along the axial direction. A positive oversize means that the electrode sheet with the oversize extends at the end over the other electrode sheet along the axial direction. A negative oversize means that the electrode sheet with the negative oversize does not extend at the end as far along the axial direction as the other electrode sheet.

In particular, the stack is formed by a large number of electrode sheets, wherein, with a plurality of spacing elements for each electrode sheet, a predetermined extension is set.

A cutting device for at least two electrode sheets is also proposed. The cutting device comprises at least one first staging device for a first electrode foil, a second staging device for a second electrode foil, a first clamping device, a spacer element and a control unit, which is set up, equipped, configured or programmed to carry out the method described.

In particular, the cutting device includes at least a second clamping device or a third clamping device. In particular, the cutting device comprises a plurality of first clamping devices, second clamping devices, third clamping devices and spacer elements. In particular, the cutting device is provided for four electrode sheets, wherein a staging device with an electrode foil is provided for each electrode sheet.

Accordingly, a control unit is also proposed that is set up, equipped, configured or programmed to carry out the described method.

The control unit can control at least a velocity of the electrode foil along the axial direction with respect to the staging devices; or the operation of at least one clamping device; or the operation of at least one spacer element; or the operation of at least one trimmer.

A spacer element for the described cutting device is also proposed. The spacer element can be arranged between the first electrode foil and the second electrode foil and, by shaping or moving said spacer element at least along a radial direction perpendicular to the axial direction and to the largest sides of the electrode foils, extends the length along the electrode foil between the first section and the respective staging device as compared to the length of the other electrode foil.

Also proposed is a trimmer for the cutting device, wherein the cutting device is suitable for four electrode sheets. The trimmer shall have at least one first spacer element to set a distance between a first electrode foil and a second electrode foil, a second spacer element to set a distance between the second electrode foil and a third electrode foil, and a third spacer element to set a distance between the third electrode foil and a fourth electrode foil. Each spacer element can be arranged between the respective electrode foils and, by shaping or moving the spacer element at least along a radial direction perpendicular to the axial direction and to the largest side faces of the electrode foils, extends the length along the respective electrode foil between the first section and the respective staging device with respect to the length of the other electrode foil.

In particular, at least one of the spacer elements includes an elastically deformable material in which a cutter is placed, wherein due to a deformation of the material, the cutter protrudes from the spacer element and thus the respective electrode foil can be cut to length.

In particular, the spacer elements each have a slit through which the respective electrode foil can be cut to length via a cutter that can be moved independently of the spacer elements, at least along the radial direction.

In particular, two cutters are provided, wherein a first cutter is movable at least along a first radial direction, cutting to length at least the first electrode foil, and a second cutter, which is movable at least along a second radial direction opposite to the first radial direction, cutting to length at least the fourth electrode foil.

A battery cell is further proposed, at least comprising a housing and arranged in it, at least one stack of electrode sheets, wherein the stack is produced by the described method.

In particular, the battery cell comprises a housing enclosing a volume and arranged in the volume, at least a first electrode sheet of a first type of electrode, a second electrode sheet of a second type of electrode and a separator material and an electrolyte arranged in between.

In particular, the battery cell is a pouch cell (with a deformable housing formed of a pouch foil) or a prismatic cell (with a dimensionally stable housing). A pouch foil is a well-known deformable housing part that is used as a housing for so-called pouch cells. It is a composite material, e.g., comprising a plastic and aluminum.

In particular, the battery cell is a lithium-ion battery cell.

The individual sheets of the plurality of electrode sheets are arranged on top of each other and form a stack. The electrode sheets are each assigned to different types of electrodes, i.e., they are designed as an anode or a cathode. Anodes and cathodes are arranged alternately and separately from each other via the separator material.

A battery cell is a power storage unit that is used, for example, in a motor vehicle to store electrical energy. In particular, for example, a motor vehicle has an electric machine for propulsion of the motor vehicle (a traction drive), wherein the electric machine is powered by the electrical energy stored in the battery cell.

Furthermore, a motor vehicle is proposed, at least comprising a traction drive and a battery with at least one of the described battery cells, wherein the traction drive can be supplied with energy by at least one battery cell.

Furthermore, the method can also be carried out by a computer or a processor of a control unit.

Accordingly, a data processing system comprising a processor adapted/configured to carry out the method or part of the steps of the proposed method is also proposed.

A computer-readable storage medium may be provided which contains instructions that, when executed by a computer/processor, cause the latter to perform the method or at least part of the steps of the proposed method.

The explanations of the method are transferable in particular to the cutting device, the spacer element, the trimmer, the battery cell, the motor vehicle, the control unit and the computer-implemented method (i.e., the computer or processor, the data processing system, the computer-readable storage medium), and vice versa.

The use of indefinite article (“a”), in particular in the claims and the description reproducing them, is to be understood as such and not as a numeral.

Concepts or components introduced in this way are therefore to be understood as meaning that they are present at least once and, in particular, can also be present several times.

For the avoidance of doubt, it should be noted that the numerals used here (“first”, “second”, . . . ) primarily serve (only) to distinguish between several similar objects, sizes or processes, i.e., in particular do not necessarily specify any dependency and/or sequence of these objects, sizes or processes in relation to each other. If a dependency and/or sequence is necessary, this is explicitly stated here or it is obvious to the skilled person when studying the specifically described design. To the extent that a component may appear more than once (“at least one”), the description of one of these components may apply equally to all or part of the plurality of those components, but this is not mandatory.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a stack of electrode sheets in a side view;

FIG. 2 shows a section of a cutting device in a top view;

FIG. 3 shows the cutting device as shown in FIG. 2 in a side view;

FIG. 4 shows the cutting device as shown in FIGS. 2 and 3 in a top view;

FIG. 5 shows a first variant of a trimmer during steps (e) and (f), in a view along the axial direction and a view transverse to the axial direction and transverse to the radial direction;

FIG. 6 shows the trimmer as shown in FIG. 5 during step g), in a view along the axial direction and in a view transverse to the axial direction and transverse to the radial direction;

FIG. 7 shows the trimmer according to FIGS. 5 and 6 after step g), in a view along the axial direction and in a view transverse to the axial direction and transverse to the radial direction;

FIG. 8 shows the trimmer as shown in FIGS. 5 to 7 during step i), in a view along the axial direction;

FIG. 9 shows a clamping device in different states, in a view along the axial direction;

FIG. 10 shows an example of a trimmer in different states, in a view transverse to the axial direction and transverse to the radial direction;

FIG. 11 shows an example of a trimmer in different states, in a view transverse to the axial direction and transverse to the radial direction;

FIG. 12 shows an example of a trimmer in a view transverse to the axial direction and transverse to the radial direction;

FIG. 13 shows the trimmer according to FIG. 12 in a first perspective view; and

FIG. 14 shows the trimmer according to FIGS. 12 and 13 in a second perspective view.

### DETAILED DESCRIPTION

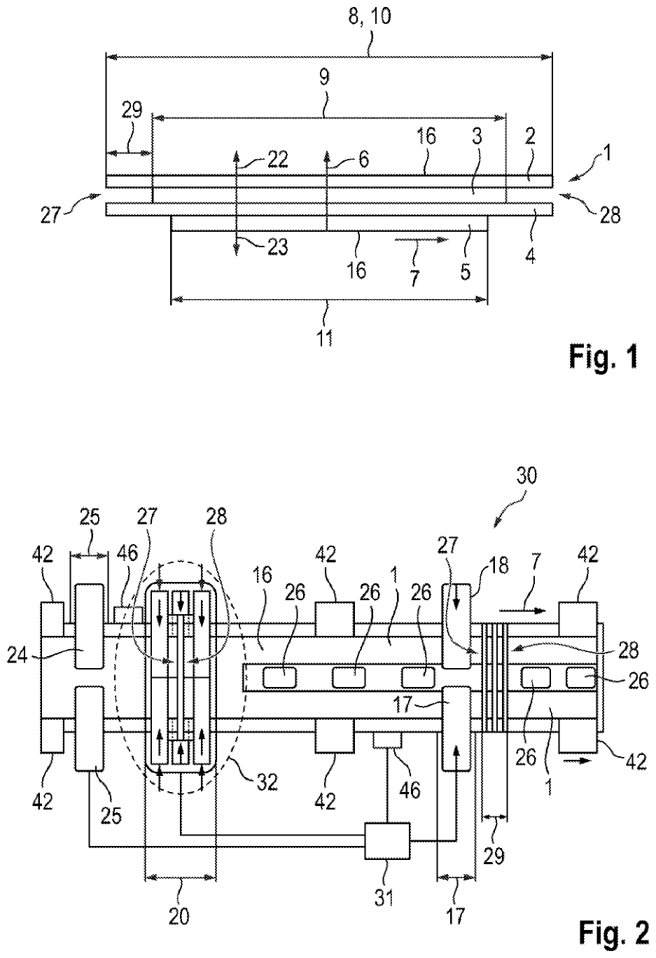

FIG. 1 shows a stack of 1 electrode sheets 2, 3, 4, 5 in a side view. The stack 1 is produced by the method described.

In battery cells, the separators are usually larger than the anodes and the anodes are larger than the cathodes. The first electrode sheet 2 with the first extension 8 along the axial direction 7 and the third electrode sheet 4 with the third extension 10 are both separators and of the same size . The second electrode sheet 3 with the second extension 9 is designed as the anode and the fourth electrode sheet 5 with the smallest fourth extension 11 as the cathode.

The separators have a circumferential oversize 29 with respect to the anode of the stack 1, e.g., a circumferential edge of 1.5 millimeters wide. The separators have a circumferential oversize 29 with respect to the cathode of the stack 1, e.g., a circumferential edge of 3 millimeters. Correspondingly, the anode has a circumferential oversize 29 with respect to the cathode of the stack 1, e.g., a circumferential edge of 1.5 millimeters.

The stack 1 has electrode sheets 2, 3, 4, 5 and along the axial direction 7 a first end 27 and a second end 28. The first electrode sheet 2 has an oversize 29 at each end 27, 28 along the axial direction 7 with respect to the second electrode sheet 3. The oversize 29 is the same size at each end 27, 28.

In stack 1, more than two electrode sheets 12, 14 are processed to form the stack 1, wherein each electrode sheet 2, 3, 4, 5 has a (negative or positive) oversize 29 in relation to the adjacent electrode sheet 2, 3, 4, 5, i.e., the electrode sheets 2, 3, 4, 5, which are arranged adjacent to each other, have different extensions 8, 9, 10, 11 along the axial direction 7. A positive oversize 29 means that the electrode sheet 2, 4 with the oversize 29 extends along the axial direction 7 at the end 27, 28 beyond the other electrode sheet 3, 5. A negative oversize 29 means that the electrode sheet 3, 5 with the negative oversize 29 does not extend as far along the axial direction 7 at the end 27, 28 as the other electrode sheet 2, 4.

Thanks to the method, electrode sheets 2, 3, 4, 5 can be stacked on top of each other with high positional accuracy along a stacking direction 6. Significantly higher speeds can be achieved than with the well-known pick and drop method.

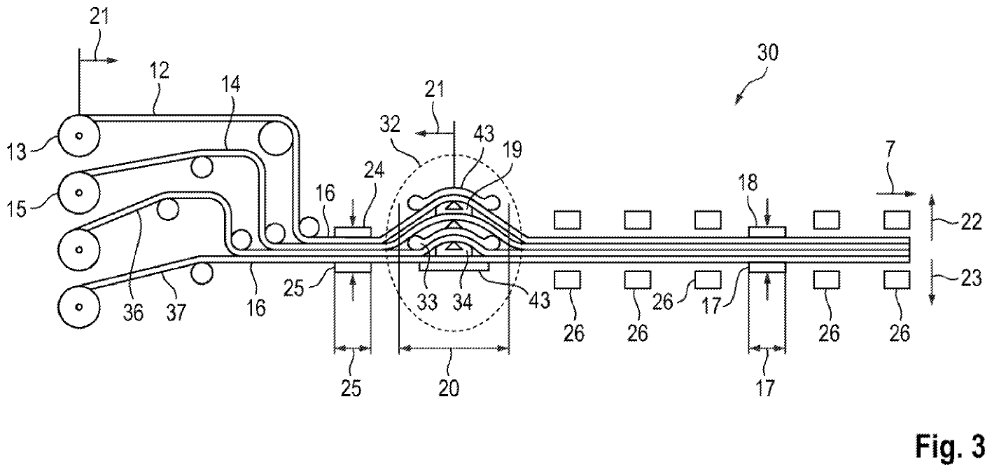

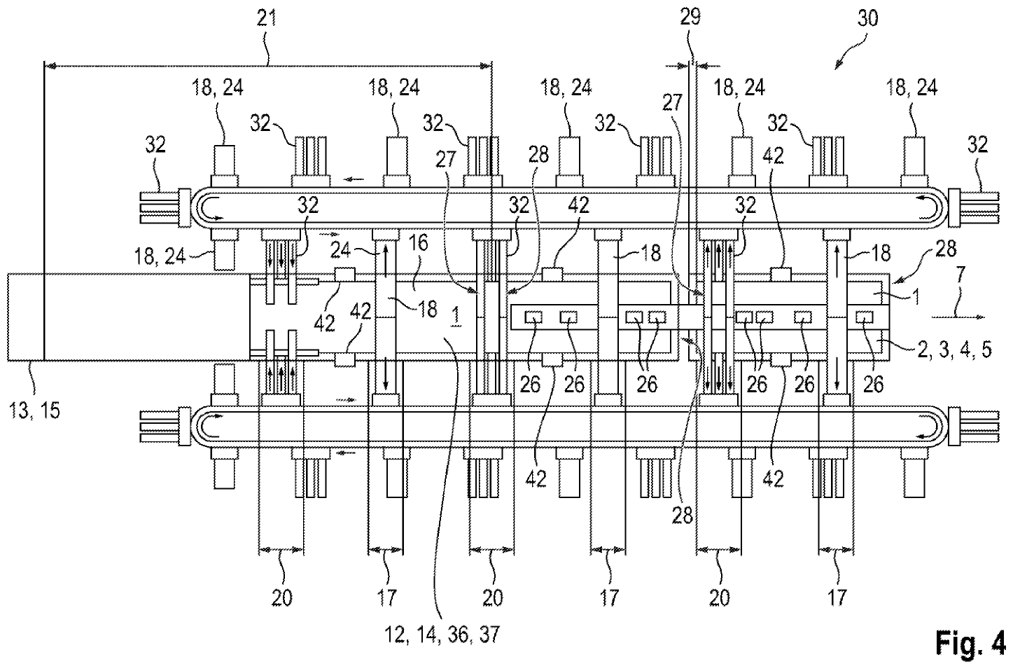

FIG. 2 shows a section of a cutting device 30 in a top view. FIG. 3 shows the cutting device 30 in a side view according to FIG. 2. FIG. 4 shows the cutting device 30 according to FIGS. 2 and 3 in a top view. FIGS. 2 to 4 are described together below. Reference is made to the explanations given in FIG. 1.

The cutting device 30 comprises a first staging device 13 for a first electrode foil 12, a second staging device 15 for a second electrode foil 14 and further staging devices for the other two electrode foils 36, 37. In addition, the cutting device 30 comprises a plurality of first clamping devices 18, second clamping devices 24, third clamping devices 26 and spacer elements 19, 33, 34 and a control unit 31.

The spacer elements 19, 33, 34 are assigned to a trimmer 32. The trimmer 32 has a first spacer element 19 for setting a distance 35 between a first electrode foil 12 and a second electrode foil 14, a second spacer element 33 for setting a distance 35 between the second electrode foil 14 and a third electrode foil 36, and a third spacer element 34 for setting a distance of 35 between the third electrode foil 36 and a fourth electrode foil 37. Each spacer element 19, 33, 34 can be arranged between the respective electrode foils 12, 14, 36, 37 and extends, by shaping or by moving the spacer element 19, 33, 34 at least along a radial direction 22, 23 running perpendicular to the axial direction 7 and to the largest side faces 16 of the electrode foils 12, 14, 36, 37, the length 21 along the respective electrode foil 12, 14, 36, 37 between the first section 17 and the respective staging device 13, 15 in relation to the length 21 of the respective other electrode foil 37, 36, 14, 12.

In steps (a) and (b) of the method, the different electrode sheets 12, 14, 36, 37 are each provided by a staging device 13, 15. Before step c), these electrode foils 12, 14, 36, 37 are fully coated and trimmed at the edges parallel to the axial direction 7. For example, the anodes and cathodes have current collectors 42 (also known as arrester tabs) at the edges.

Step (c) involves the merging of electrode foils 12, 14, 36, 37 so that they are arranged opposite or on top of each other with their largest side faces 16. The electrode foils 12, 14, 36, 37, which are available as continuous material, are arranged in alignment with each other with their edges running parallel to the axial direction 7, or in the position of these edges provided for in the later stack 1 of the electrode sheets 2, 3, 4, 5. For example, the electrode foils are arranged in such a way that the nominal oversize 29 of the electrode sheets 2, 3, 4, 5 present in the stack 1 is set with respect to the edges parallel to the axial direction 7.

According to step d), the electrode foils 12, 14, 36, 37 arranged on top of each other are fixed together in a first section 17 via a first clamping device 18. For example, the first clamping device 18 comprises two clamping jaws 43 between which the electrode foils 12, 14, 36 and 37 are clamped (see, for example, FIG. 9). The first clamping device 18 contacts only the largest side faces 16 of the electrode foils 12, 37, i.e., the underside of the fourth electrode foil 37 and the top of the first electrode foil 12.

According to step e), a spacer element 19, 33, 34 is placed between the electrode foils 12, 14, 36, 37 in a second section 20, which is located along the axial direction 7 between the first section 17 and the staging devices 13, 15. In this second section 20, the electrode foils 12, 14, 36, 37 are arranged at a small distance from each other, so that the spacer element 19, 33, 34 can be inserted or swiveled in between the electrode foils 12, 14, 36, 37 and along a direction perpendicular to the axial direction 7 and to the radial direction 22, 23.

According to step (f), at least three of the electrode foils 12, 14, 36, 37 are extended in length 21, wherein the length 21 extends along the electrode foil 12, 14, 36, 37 between the first section 17 and the respective staging device 13, 15. The extension of the length 21 in relation to the length 21 of the respective other electrode foil 12, 14, 36, 37 is carried out by at least shaping the spacer element 19, 33, 34 or moving the spacer element 19, 33, 34 at least along a radial direction 22, 23. The measure of the extension of the electrode foil 12, 14, 36, 37 is provided by the respective staging device 13, 15, e.g., by unwinding the measure of the extension, since in the first section 17 the electrode foils 12, 14, 36, 37 are arranged clamped together.

According to step (g), the electrode sheets 12, 14, 36, 37 are cut in the second section 20, so that between the first section 17 and the second section 20 there is a stack 1 of electrode sheets 2, 3, 4, 5, each with different extensions 8, 9, 10, 11.

A cutter 39, 41 is provided for the cutting, which is designed as a component of the respective spacer element 19, 33, 34 or interacts with it.

The cutting of the electrode foils 12, 14, 36, 37 is carried out in such a way that the spacer element 19, 33, 34, sets an extension of the length 21 between the first section 17 and the second section 20, more precisely between the first section 17 and the separation point in the second section 20.

Furthermore, the electrode foils 12, 14, 36, 37 are cut in such a way via the spacer element 19, 33, 34, the extension of the length 21 between the first section 17 and the second section 20 and the extension of the length 21 between the second section 20 and the respective staging device 13, 15 are equal. Thus, the electrode sheet 2, 3, 4, 5 formed by cutting the electrode foil 12, 14, 36, 37 at each end 27, 28 along the axial direction 7 can have an equally large oversize 29 as compared to the other electrode sheet 5, 4, 3, 2.

In the second section 20, clamping jaws 43 are also provided, via which the electrode foils 12, 14, 36, 37 and the spacer elements 19, 33, 34 are fixed in their position in relation to each other. These are allocated to the at least one spacer element 19, 33, 34 or to the trimmer 32.

According to step (g), the electrode sheets 2, 3, 4, 5 are generated, wherein each electrode sheet 2, 3, 4, 5 is produced with its own extension 8, 9, 10, 11 along the axial direction 7. The individual electrode sheets 2, 3, 4, 5 of the stack 1 are already arranged on top of each other with the correct oversize 29 with respect to the axial direction 7 and can thus be further processed.

Between steps (f) and (g), in step x., the electrode foils 12, 14, 36, 37 arranged on top of each other are fixed together by a second clamping device 24 in a third section 25, which is arranged between the second section 20 and the staging devices 13, 15. The example for the first clamping device 18 applies equally to the second clamping device 24.

The fixing according to step x. always takes place only after step f), so that the extension of the length 21 of the respective electrode foil 12, 14, 36, 37, which is provided by unwinding from the staging device 13, 15, is not impaired or prevented. As a result of the fixing by the second clamping device 24, it is ensured that the electrode foils 12, 14, 36, 37 are fixed in their respective positions in relation to each other after the electrode sheets 2, 3, 4, 5 have been separated.

Between steps x. and g), the first clamping device 18, the second clamping device 24 and the spacer elements 19, 33, 34, together with the fixed electrode foils 12, 14, 36, 37, are shifted along the axial direction 7 and thereby additional electrode foil 12, 14, 36, 37 material is unrolled from the staging devices 13, 15.

This makes it possible to realize series production in which the individual method steps are carried out in constant repetition on the electrode foils 12, 14, 36, 37, so that a large number of stacks 1 can be produced one after the other.

After step g), in a further step h), the stack 1 of electrode sheets 2, 3, 4, 5 is fixed by a third clamping device 26. The third clamping device 26 is arranged along the axial direction 7 between the first section 17 (or the first clamping device 18) and the second section 20. The explanations to the first and second clamping devices 18, 24 apply mutatis mutandis.

After step h), in a further step i), the spacer elements 19, 33, 34 are removed from the stack 1 and the first clamping device 18 is released. First, the spacer elements 19, 33, 34 are removed from the stack 1 and then the first clamping device 18 is released. The electrode sheets 2, 3, 4, 5 continue to be fixed by the third clamping device 26 and thus fixed in their position in relation to each other.

After step i), in a further step j), the stack 1 of electrode sheets 2, 3, 4, 5 is transported further by the third clamping device 26. This stack 1 of electrode sheets 2, 3, 4, 5 can, e.g., be put to further use with the third clamping device 26.

After step i), e.g., parallel in time to step j), in a further step k), the second clamping device 24 and the electrode foils 12, 14, 36, 37 fixed by it are shifted along the axial direction 7. This makes it possible to realize series production in which the individual method steps are carried out in constant repetition on the electrode foils 12, 14, 36, 37, so that a large number of stacks 1 can be produced one after the other.

According to step (k), the second clamping device 24 forms the first clamping device 18 and the method is continued with step (e). According to step k), the second clamping device 24 thus forms the first clamping device 18 and thus already implements step d) of the method.

The cutting device 30 also has sensors 46 (e.g., cameras) that can be used to detect and monitor the position of the edges of the electrode foils 12, 14, 36, 37 or the electrode sheets 2, 3, 4, 5 running parallel to the axial direction 7. If a deviation in the position of an electrode foil 12, 14, 36, 37 is detected, this position can be corrected by the cutting device 30.

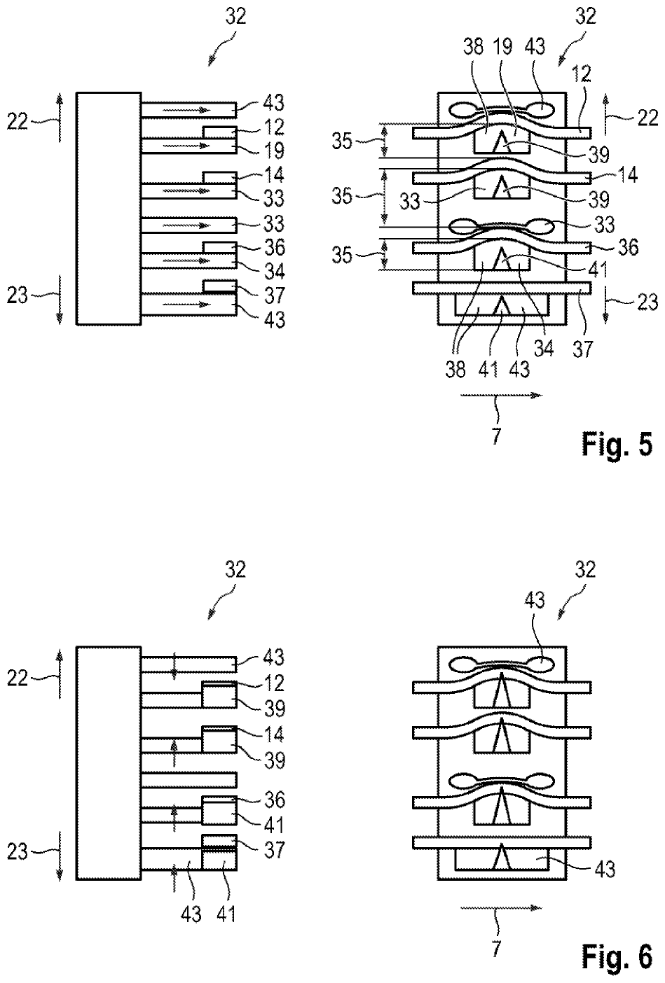

FIG. 3 and the following FIGS. 5 to 8, 10 and 11 show simplified geometries of the spacer elements 19, 33, 34. With a more complex geometry and corresponding guidance of the relevant electrode foils 12, 14, 36, 37, the desired length 21 of the electrode sheets 12, 14, 36, 37 and the extension 8, 9, 10, 11 of the electrode sheets 2, 3, 4, 5 can be set.

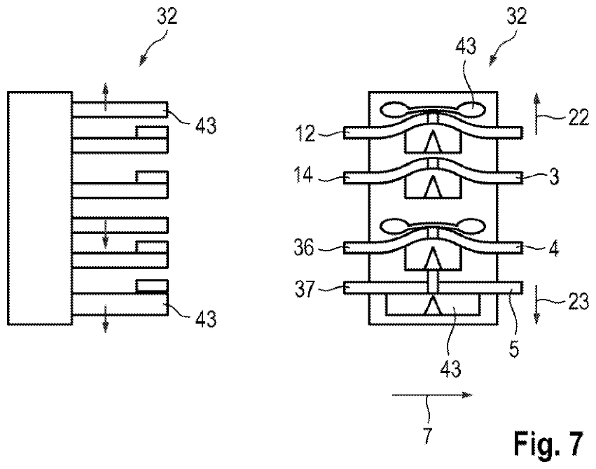

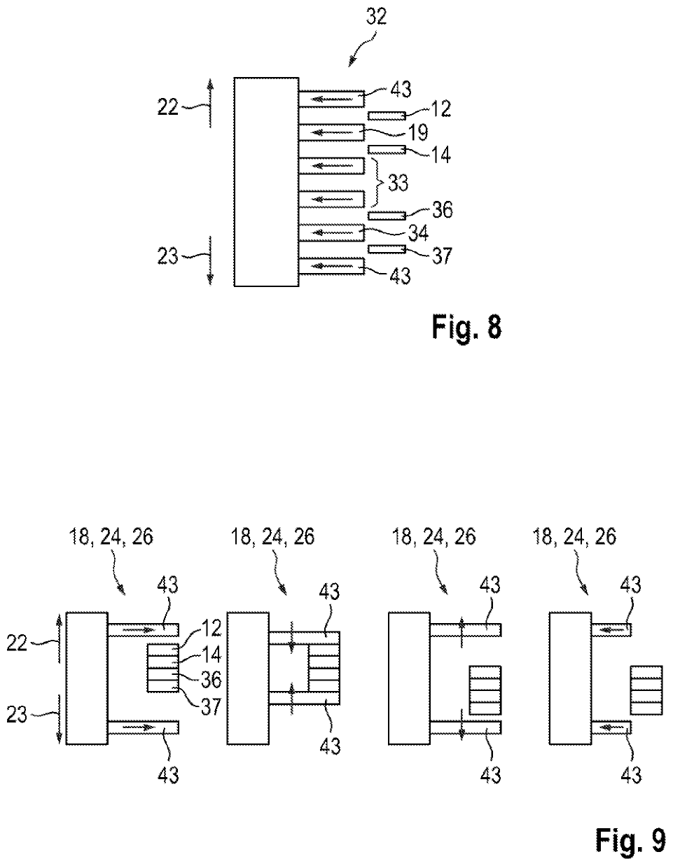

FIG. 5 shows a first example of a trimmer 32 during steps e) and f), in a view along the axial direction 7 (left side) and in a view transverse to the axial direction 7 and transverse to the radial direction 22, 23 (right side). FIG. 6 shows the trimmer 32 according to FIG. 5 during step g), in a view along the axial direction 7 and in a view transverse to the axial direction 7 (left side) and transverse to the radial direction 22, 23 (right side). FIG. 7 shows the trimmer 32 according to FIGS. 5 and 6 according to step g), in a view along the axial direction 7 (left side) and in a view transverse to the axial direction 7 and transverse to the radial direction 22, 23 (right side). FIG. 8 shows the trimmer 32 according to FIGS. 5 to 7 during step i), in a view along the axial direction 7. Reference is made to the explanations given in FIGS. 2 to 4.

The trimmer 32 has a first spacer element 19 for setting a distance 35 between a first electrode foil 12 and a second electrode foil 14, a second spacer element 33 for setting a distance 35 between the second electrode foil 14 and a third electrode foil 36, and a third spacer element 34 for setting a distance 35 between the third electrode foil 36 and a fourth electrode foil 37. Each spacer element 19, 33, 34 can be arranged between the respective electrode foils 12, 14, 36, 37 and extends, by shaping and moving the spacer element 19, 33, 34 at least along a radial direction running transversely to the axial direction 7 and to the largest side faces 16 of the electrode foils 12, 14, 36, 37 22, 23, the length 21 along the respective electrode foil 12, 14, 36, 37 between the first section 17 and the respective staging device 13, 15 in relation to the length 21 of the respective other electrode foil 37, 36, 14, 12.

Clamping jaws 43 are also provided, via which the electrode foils 12, 14, 36, 37 and the spacer elements 19, 33, 34 are fixed in their position in relation to each other. These are allocated to at least one spacer element 18, 33, 34 or to the trimmer 32.

According to step e), a spacer element 19, 33, 34 is placed between the electrode foils 12, 14, 36, 37 in the second section 20. In this second section 20, the electrode foils 12, 14, 36, 37 are arranged at a small distance from each other, so that the spacer element 19, 33, 34 can be inserted or swiveled in between the electrode foils 12, 14, 36, 37 and along a direction perpendicular to the axial direction 7 and to the radial direction 22, 23.

According to step (f), a length 21 of at least three of the electrode foils 12, 14, 36, 37 is extended, wherein the length 21 extends along the electrode foil 12, 14, 36, 37 between the first section 17 and the respective staging device 13, 15. The length 21 is extended in relation to the length 21 of the other electrode foil 12, 14, 36, 37 by shaping the spacer element 19, 33, 34 and by moving the spacer element 19, 33, 34 along a radial direction 22, 23.

According to step (g), the electrode sheets 12, 14, 36, 37 are cut in the second section 20, so that between the first section 17 and the second section 20 there is a stack 1 of electrode sheets 2, 3, 4, 5, each with different extensions 8, 9, 10, 11. For cutting, in each case one cutter 39, 41 is provided, which is designed as a component of or interacts with the respective spacing element 19, 33, 34.

The spacer elements 19, 33, 34 have an elastically deformable material 38 in which a cutter 39, 41 is arranged, wherein the cutter 39, 41 protrudes from the spacer element 19, 33, 34 due to a deformation of the material 38 and thus the respective electrode foil 12, 14, 36, 37 can be cut to length. For cutting, the clamping jaws 43 are brought together so that the elastically formable material of the spacer elements 19, 33, 34 is compressed and the respective cutter 39, 41 can emerge from the spacer element 19, 33, 34 to cut through the electrode foil 12, 14, 36, 37.

According to step (g), the electrode sheets 2, 3, 4, 5 are generated, wherein each electrode sheet 2, 3, 4, 5 is produced with its own extension 8, 9, 10, 11 along the axial direction 7. The individual electrode sheets 2, 3, 4, 5 of the stack 1 are already arranged on top of each other with the correct oversize 29 with respect to the axial direction 7 and can thus be further processed.

In a step i), the clamping jaws 43 are released and the spacer elements 19, 33, 34 are removed from the stack 1.

FIG. 9 shows a clamping device 18, 24, 26 in different states; in a view along the axial direction 7. The clamping device 18, 24, 26 includes two clamping jaws 43, between which the electrode foils 12, 14, 36, 37 are clamped. In doing so, the clamping device 18, 24, 26 exclusively contacts the largest side faces 16 of the electrode foils 12, 37, i.e., the underside of the fourth electrode foil 37 and the top of the first electrode foil 12.

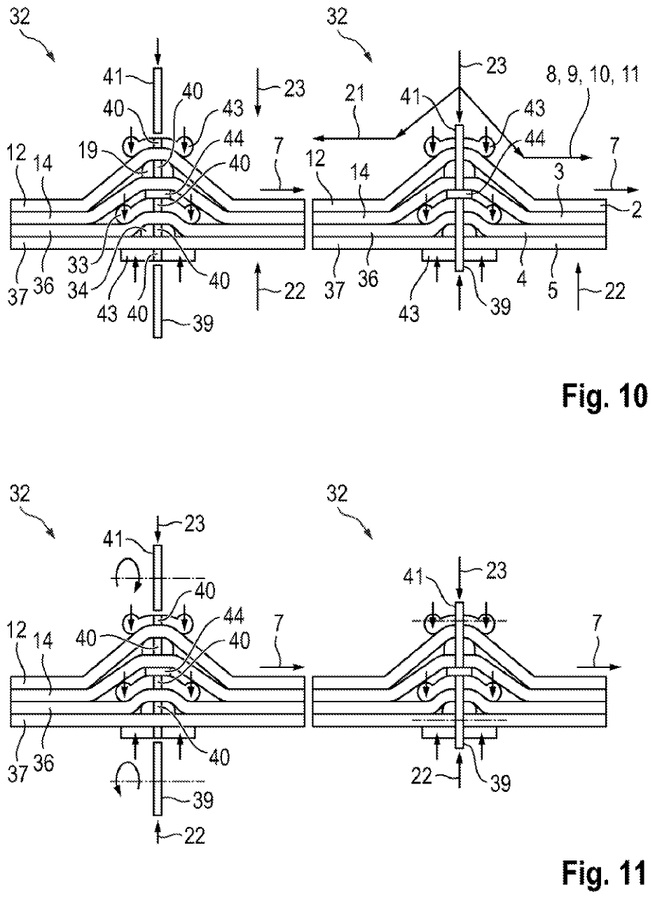

FIG. 10 shows a second example of a trimmer 32 in different states (left side: before cutting; right side: during cutting), in a view transverse to the axial direction 7 and transverse to the radial direction 22, 23. Reference is made to the explanations given in FIGS. 5 to 8.

In contrast to the first example, the spacer elements 19, 33, 34 and the clamping jaws 43 each have a slit 40, through which the respective electrode foil 12, 14, 36, 37 can be cut to length by a cutter 39, 41 which can be moved independently at least along the radial direction 22, 23 with respect to the spacer elements 12, 14, 36, 37.

Two cutter 39, 41 are provided, wherein a first cutter 39 is movable exclusively along a first radial direction 22 towards the electrode foils 36, 37 (and back) and cuts the third and fourth electrode foils 36, 37 to length, and a second cutter 41 moves exclusively along a second radial direction 23 (and back) directed in the opposite direction to the first radial direction 22 and cuts the first and second electrode foils 12, 14 to length.

An intermediate disc 44 is arranged between the second electrode foil 14 and the second spacer element 33 to ensure that the cutter 39, 41 do not collide with each other.

FIG. 11 shows a third example of a trimmer 32 in different states (left side: before cutting; right side: during cutting), in a view transverse to the axial direction 7 and transverse to the radial direction 22, 23. Reference is made to the explanations given in

FIG. 10.

In contrast to the second example, the cutter 39, 41 are swiveled by 90 degrees, wherein the axis of rotation (indicated on the left side) of the cutter 39, 41 is stationary, or rotates about an axis of rotation, wherein the axis of rotation of the cutter 39, 41 is moved to cut the electrode foils 12, 14, 36, 37 along the radial direction 22, 23.

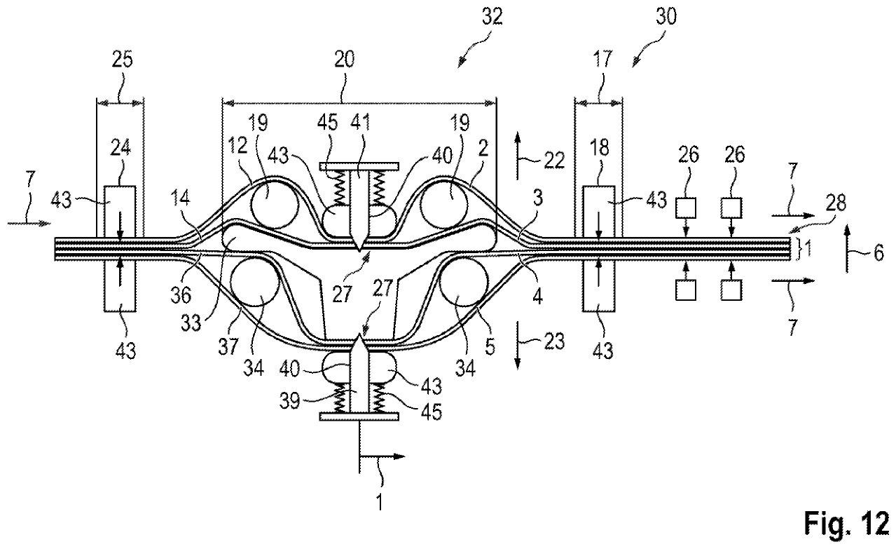

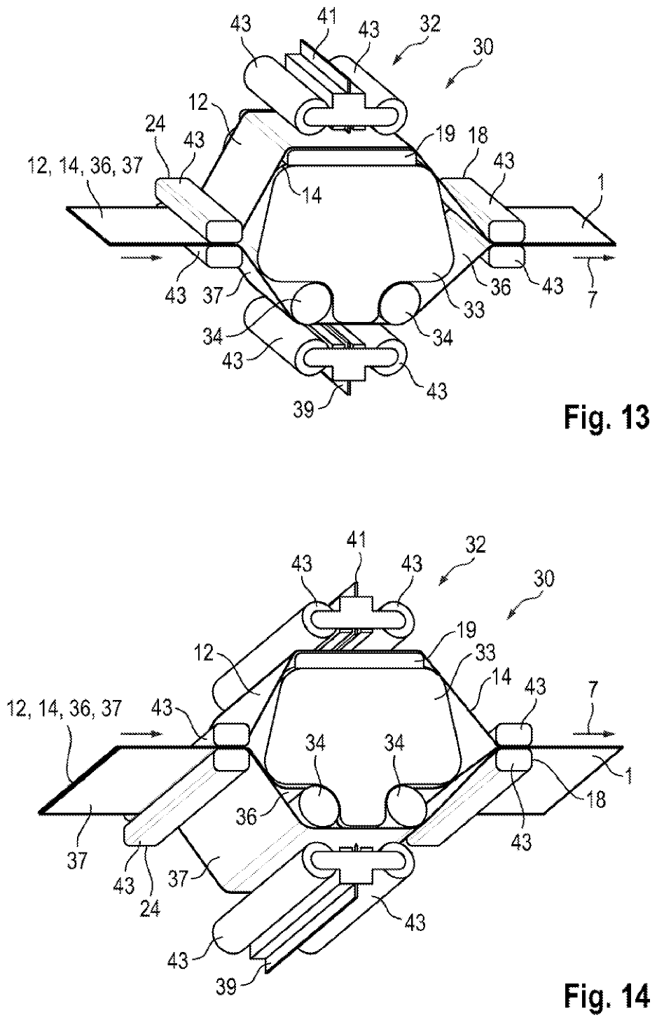

FIG. 12 shows a fourth example of a trimmer 32, in a view transverse to the axial direction 7 and transverse to the radial direction 22, 23. FIG. 13 shows the fourth example of a trimmer 32 according to FIG. 12 in a first perspective view. FIG. 14 shows the fourth example of a trimmer 32 according to FIGS. 12 and 13 in a second perspective view. FIGS. 12 to 14 are described together below. Reference is made to the explanations given in FIGS. 1 to 11.

FIG. 12 shows the trimmer 32 as part of the cutting device 30, which comprises a first clamping device 18, a second clamping device 24, several third clamping devices 26 and spacer element 19, 33, 34.

The trimmer 32 has a first spacer element 19 for setting a distance 35 between a first electrode foil 12 and a second electrode foil 14, a second spacer element 33 for setting a distance 35 between the second electrode foil 14 and a third electrode foil 36, and a third spacer element 34 for setting a distance 35 between the third electrode foil 36 and a fourth electrode foil 37. Each spacer element 19, 33, 34 can be arranged between the respective electrode foils 12, 14, 36, 37 and, by shaping the spacer elements 19, 33, 34, extends the length 21 along the respective electrode foil 12, 14, 36, 37 between the first section 17 and the respective staging device 13, 15 with respect to the length 21 of the respective other electrode foil 37, 36, 14, 12.

Clamping jaws 43 are also provided, via which the electrode foils 12, 14, 36, 37 and the spacer elements 19, 33, 34 are fixed in their position in relation to each other. These are allocated to at least one spacer element 18, 33, 34 or to the trimmer 32. The clamping jaws 43 have slits 40, through which cutter 39, 41 can cut the electrode foils 12, 14, 36, 37, i.e., cut them to length. The cutter 39, 41 have return springs 45.

The extension of the electrode foils 12, 14, 36, 37 is realized by a kind of labyrinth guide of the electrode foils 12, 14, 36, 37, wherein the shape of the spacer elements 19, 33, 34 creates this labyrinth. This means that an electrode foil 12, 14, 36, 37 can be extended almost arbitrarily, regardless of its position in the stack 1. The measure of the extension of the electrode foil 12, 14, 36, 37 is provided by the staging device, e.g., by unwinding the measure of the extension, since in the first section 17 the electrode foils 12, 14, 36, 37 are arranged clamped together.

Here, the first and third electrode foil 12, 36 are designed as separators, the second electrode foil 14 as a cathode and the fourth electrode foil 37 as an anode.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a stack of electrode sheets, wherein the stack comprises at least two electrode sheets arranged on top of each other along a stacking direction, which have, at least along an axial direction that is substantially perpendicular to the direction of the stack, a different extension, the method comprising:
a) providing a first electrode foil as continuous material from a first staging device;
b) providing a second electrode foil as continuous material from a second staging device;
c) bringing the electrode foils together so that they are arranged opposite each other, each with their largest side faces;
d) jointly fixing the electrode foils arranged on top of each other in a first section via a first clamping device;
e) arranging a spacer element between the electrode foils in a second section, which is arranged along the axial direction between the first section and the staging devices;
f) lengthening the length of at least one of the electrode foils, wherein the length extends along the electrode foil between the first section and the respective staging device with respect to the length of the other electrode foil by at least shaping the spacer element or by moving the spacer element at least along a radial direction substantially perpendicular to the axial direction and to the largest side faces; and
g) cutting the electrode foils to length in the second section so that a stack of electrode sheets with different extensions is formed between the first section and the second section.

2. The method according to claim 1, wherein between steps (f) and (g), in a step x. a joint fixation of the electrode foils arranged on top of each other is carried out via a second clamping device in a third section, which is located between the second section and the staging devices.

3. The method according to claim 2, wherein between steps x. and g), in a step y. the first clamping device, the second clamping device and the spacer element, together with the fixed electrode foils, are shifted along the axial direction.

4. The method according to claim 3, wherein after step g), in a further step h) the stack of electrode sheets is fixed by a third clamping device.

5. The method according to claim 4, wherein after step h), in a further step i) the spacer element is removed from the stack and the first clamping device is released.

6. The method according to claim 5, wherein after step i), in a further step j) the stack is transported further by the third clamping device.

7. The method according to claim 5, wherein after step (i), in a further step (k) the second clamping device and the electrode foils fixed by the second clamping device are moved along the axial direction.

8. The method according to claim 7, wherein after step (k) the second clamping device forms the first clamping device and the method is continued with step (e).

9. The method according to claim 1, wherein the stack has at least one first electrode sheet and a second electrode sheet and a first end and a second end along the axial direction, and wherein the first electrode sheet has an oversize at each end along the axial direction with respect to the second electrode sheet.

10. The method according to claim 1, wherein the stack is formed by a large number of electrode sheets, wherein a predetermined extension is set with a plurality of spacing elements for each electrode sheet.

11. A cutting device for at least two electrode sheets, the cutting device comprising:
a first staging device for a first electrode foil;
a second staging device for a second electrode foil;
a first clamping device;
a spacer element; and
a control unit designed to carry out the method according to claim 1.

12. A spacer element for a cutting device according to claim 11, which is adapted to be arranged between the first electrode foil and the second electrode foil and which, by shaping or moving the spacer element at least along a radial direction that is substantially perpendicular to the axial direction and towards the largest side faces of the electrode foils, extends a length along the electrode foil between the first section and the respective staging device with respect to a length of the other electrode foil.

13. A trimmer for a cutting device according to claim 11, wherein the cutting device is suitable for four electrode sheets, wherein the trimmer comprises:
at least one first spacer element to set a distance between a first electrode foil and a second electrode foil;
a second spacer element to set a distance between the second electrode foil and a third electrode foil; and
a third spacer element to set a distance between the third electrode foil and a fourth electrode foil,
wherein each of the first, second, and third spacer elements are adapted to be arranged between the respective electrode foils and, by shaping or moving the spacer element at least along a radial direction substantially perpendicular to the axial direction and to the largest side faces of the electrode foils, extends a length along the respective electrode foil between the first section and the respective staging device with respect to a length of the other electrode foil.

14. The trimmer according to claim 13, wherein at least one of the spacer elements comprises an elastically deformable material in which a cutter is arranged, wherein by deformation of the material, the cutter protrudes from the spacer element and thus the electrode foil is cut to length.

15. The trimmer according to claim 13, wherein the spacer elements each have a slit through which the respective electrode foil is cut to length by a cutter, which is independently movable at least along the radial direction with respect to the spacer elements.

16. The trimmer according to claim 15, wherein two cutters are provided, wherein a first cutter is movable at least along a first radial direction and cuts at least the first electrode foil to length, and a second cutter is movable at least along a second radial direction directed opposite of the first radial direction, which cuts the at least the fourth electrode foil.
